(19) United States
(12) Patent Application Publication
(10) Pub. No.: US 2012/0029867 A1
(43) Pub. Date: Feb. 2, 2012

(54) METHOD AND SYSTEM FOR INTEGRATED TIMING MEASUREMENTS

(75) Inventors: George Maher, Herndon, VA (US); Tosin Osinusi, Frederick, MD (US); John Carlson, Dulles, VA (US)

(73) Assignee: Andrew LLC, Hickory, NC (US)

(21) Appl. No.: 13/147,887

(22) PCT Filed: Feb. 17, 2010
(86) PCT No.: PCT/US10/24348

§ 371 Date: Aug. 4, 2011

Related U.S. Application Data
(60) Provisional application No. 61/153,169, filed on Feb. 17, 2009.

(51) Int. Cl. G06F 15/00

(52) U.S. Cl. 702/150

(57) ABSTRACT

A method and system for determining the location of a mobile appliance in a communications system having a plurality of nodes. The plurality of nodes are tasked to measurement the time of arrival (TOA) of the signal transmitted by the mobile appliance in an assigned time slot across multiple frames of data. TOA measurement data may be derived from ones of the multiple frames of data where the derived TOA measurement data is non-coherently integrated across the ones of the multiple frames of data. A location estimate of the mobile appliance may then be determined as a function of the derived TOA measurement data.

### RELATED APPLICATIONS

The instant application is a national stage application of PCT Application No. PCT/US2010/024348 entitled “Method and System for Integrated Timing Measurements”, having an International Filing Date of 17 Feb. 2010. The instant application claims the priority benefit of co-pending U.S. Provisional Patent Application No. 61/153,169 filed Feb. 17, 2009 and entitled, “Method and System for Integrated Timing Measurements,” the entirety of which is incorporated herein by reference.

### BACKGROUND

Embodiments of the present subject matter provide methods and systems for an accurate location of a mobile cellular telephone using integrated signal time of arrival (“TOA”) measurements.

In a time division multiplex (“TDM”) cellular air standard such as GSM, each user is assigned a time slot that repeats every 8-slot frame. In a time difference of arrival (“TDOA”) based geolocation system, TOA measurements of a mobile station (“MS”) signal in each time slot may be determined at several sensor sites in the vicinity of the MS. The site at which the signal is strongest may be generally selected as the primary site, with the other sensor sites referred to as secondary sites.

An ambiguity function (“AF”) is a well known function for measuring the TOA of a known reference signal within a second signal received at a sensor. The AF also determines the frequency offset, or frequency of arrival (“FOA”), between the two signals. The FOA may be useful when there is large relative motion between the MS and sensors. A difference in TOA at each site with respect to a designated primary site may result in hyperbolic curves of a possible location of the MS. A position estimation algorithm such as a maximum likelihood estimate (“MLE”) may then be utilized at a central location server (“LS”) to solve for the location of the MS using the TDOA measurements from each time slot.

### SUMMARY

Embodiments of the present subject matter, however, provide methods and systems for computing a single non-coherently integrated (“NCI”) TOA measurement from individual time-slot TOAs derived from the AF across multiple frames. In these embodiments, integration of the signal across time slots from multiple frames improves the ability to detect a weak signal and results in a more accurate TOA measurement than is obtained from the conventional TOA measurements in individual time slots. The NCI TOA may thus be used in place of the individual slotted TOAs in the location algorithm thereby resulting in a more accurate MS location. In yet another embodiment, an exemplary NCI TOA may be used in a hybrid fashion at sites receiving weak signals while the slotted TOA measurements are utilized at the sites receiving stronger signals.

One embodiment of the present subject matter provides a method for determining the location of a mobile appliance in a communications system having a plurality of nodes. The method may include the steps of tasking one or more of the plural nodes to collect multiple frames of data from one or more signals transmitted by the mobile appliance and deriving TOA measurement data from ones of the multiple frames of data. A location may then be determined for the mobile appliance as a function of the derived TOA measurement data where the derived TOA measurement data is non-coherently integrated across the ones of the multiple frames of data.

Another embodiment of the present subject matter may provide a method for determining the location of a mobile appliance in a communications system having a plurality of nodes. The method may include collecting multiple frames of signal data transmitted by the mobile appliance and determining TOA measurements for ones of the multiple frames using an ambiguity function. A TOA quality metric may be determined for the ones of the multiple frames, and then a location of the mobile appliance determined as a function of the determined TOA measurements and TOA quality metric, wherein the TOA quality metric may be used to filter or weight one or more of the determined TOA measurements.

One embodiment of the present subject matter provides a method for determining the location of a mobile appliance. The method may include collecting multiple time slots of signal data transmitted by the mobile appliance and determining TOA measurements for each of the collected multiple slots using an ambiguity function. The method may also include determining a TOA quality metric, filtering TOA measurements as a function of the quality metric, and combining filtered TOA measurements into a composite TOA measurement as a function of a sum of corresponding ambiguity function magnitudes. A location estimate of the mobile appliance may then be determined as a function of the composite TOA measurement.

A further embodiment of the present subject matter provides a method of determining the location of a mobile device in a communications system having a plurality of nodes as a function of TOA measurement data derived from signals received from the device at the nodes. The method may include the step of determining a non-coherently integrated TOA measurement from multiple individual TOA measurements.

In an additional embodiment of the present subject matter, a method is provided for determining the location of a mobile device in a communications system having a plurality of nodes as a function of TOA measurement data derived from signals received from the device. The method may include the step of using a non-coherently integrated TOA measurement at a particular node in the determination of the location estimate if there is insufficient individual time slot TOA measurement data from the particular node that exceeds a predetermined TOA measurement quality threshold.

In a further embodiment of the present subject matter a method for determining the location of a mobile appliance in a communications system having a plurality of nodes. The method may include tasking one or more of the plural nodes to synchronously collect data transmitted by the mobile appliance and creating a reference signal for data collected by a first node in a particular time slot. The reference signal may be correlated with data collected by multiple secondary nodes in the same time slot using an ambiguity function. A quality metric may also be determined as a function of a degree of correlation between the reference signal and data collected by the secondary nodes. A location estimate of the mobile appliance may then be determined as a function of the TOA data collected by the first and secondary nodes and the determined quality metric.

### BRIEF DESCRIPTION OF THE DRAWINGS

Various aspects of the present disclosure will be or become apparent to one with skill in the art by reference to the following detailed description when considered in connection with the accompanying exemplary non-limiting embodiments.

FIG. 1 is a block diagram of one embodiment of the present subject matter.

FIG. 2 is a block diagram of another embodiment of the present subject matter.

FIG. 3 is a block diagram of a further embodiment of the present subject matter.

FIG. 4 is a block diagram of additional embodiments of the present subject matter.

FIG. 5 is a block diagram of one embodiment of the present subject matter.

### DETAILED DESCRIPTION

With reference to the figures where like elements have been given like numerical designations to facilitate an understanding of the present subject matter, the various embodiments of a system and method for integrated timing measurements are provided.

As discussed above, the ambiguity function (“AF”) is a well known function used for measuring the time of arrival (“TOA”) of a known reference signal within a second signal received at a sensor. In certain embodiments of the present subject matter, the AF may also be utilized to determine the frequency of arrival (“FOA”), which may be useful when there is large relative motion between the MS and the sensors.

The AF may generally be defined by the following relationship

A(f,τ)=∫₀^{T}s₁(t)s*₂(t+τ)ₑ^{-(j2πft)}dt (1)

where s₁(t) represents the complex reference signal, s*₂(t) represents the complex conjugate of the signal received at the sensor, τ represents the time lag between the two signals, and f represents the two signals' frequency offset. In certain embodiments, the time and frequency offset parameters may also be adjusted to find the values that maximize the magnitude of the AF.

In one embodiment of the present subject matter, multiple sensors may be tasked to collect data synchronously. A reference signal for the MS signal transmission in the time slot of interest, generally termed a “burst” in GSM parlance, may be created from the signal received by the primary sensor. This burst may be correlated against the signal received at secondary sites using the AF. The location of the peak of the |AF| in the time and frequency offset parameter space may provide TOA and FOA measurements. A degree of correlation between the reference and received signal may also provide a TOA quality metric. TDOAs between primary and secondary sites and the associated measurement qualities, may then be passed to an exemplary position estimation calculation engine to determine the location of the respective mobile station (“MS”). In a further embodiment, a measurement quality may also be utilized to weight the respective measurement from each sensor to adjust the amount of influence the measurement has on the computed location estimate. For example, in one embodiment of the present subject matter a measurement quality threshold may be applied prior to computing a location estimate of an MS or mobile appliance to filter low quality measurements.

In the GSM air standard, for example, eight consecutive time slots (typically from eight different users) may be grouped into a frame. Of course, while the GSM air standard has been described in this and other examples, the methods disclosed herein may also find utility in other air standards such as IS-136, etc. In a geolocation application, multiple frames of signal data may be collected and a TOA and associated TOA measurement quality derived from each slot to improve the location estimate in comparison to the estimate obtained from only a single slot TOA. In one embodiment of the present subject matter, TOA data from multiple slots may be fused to determine the location from each time slot TOA. These locations may then be averaged to determine a final location estimate for an MS. In another embodiment, a less computationally expensive method may combine individual slot TOA measurements into a single composite TOA measurement prior to determining a location estimate. In yet a further embodiment, the average or median of the slotted TOAs may also be employed as the single TOA value. Further, the amount of variation in the TOAs across adjacent or multiple time slots may provide a measure of the composite TOA quality.

In one embodiment of the present subject matter, an improved method for creating a composite TOA measurement from multiple individual time slot TOA measurements may be provided. For example, a single composite TOA measurement may be created directly at an exemplary measurement sensor by summing individual AF magnitudes across adjacent or multiple time slots. As the reference signal is time-shifted and correlated with the received signal, the correlation value should ideally peak at the true value of the time offset of the two signals. The presence of noise in the received signal may, however, introduce error in the correlation peak location, which increases as the SNR decreases.

Illustrating the effect of noise, it may be assumed that each sample of the received signal, sᵢ, is corrupted by additive Gaussian noise nᵢ. The received signal may be correlated against a reference signal, x_{i.} At each time offset, the value of the correlation may be represented as:

Σ(sᵢ+nᵢ)*xᵢ=Σsᵢ*xᵢ+Σnᵢ*xᵢ (2)

In low signal-to-noise ratio conditions, there may be considerable power in the second term masking the true correlation value at that respective offset. An exemplary non-coherent integration process of summing AF bin magnitudes across time slots has experimentally been shown to effectively sift out signal energy contained in a time-frequency correlation offset bin that is masked by noise in any individual slot. For example, as AF magnitudes are summed, the random effects of the noise power cancel each other out; however, the non-random signal similarities add constructively and a peak may form at the correct time lag. The AF magnitude at each offset may thus more closely resemble the true correlation value. This effect thus drives the improved detection performance embodied by the claimed subject matter thereby allowing a useable measurement to be derived at signal-to-noise ratio levels for which the corresponding conventional slotted TOAs would fail. This composite TOA value is also more accurate on average than any conventional TOA derived from averaging the slotted TOAs. Since the composite AF has less noise influence, the final TOA value, which may be derived by interpolation between correlation time-offset lags, is likely to be more accurate.

It should also be noted that the height of the integrated |AF| correlation peak above the noise level may provide an indication of the quality of the integrated TOA measurement. Since the integration process is a summation of non-negative numbers (e.g., AF magnitudes), the summations in each AF bin may increase for both the signal bin(s) and noise bin(s), although the sum may be much larger at the signal location. To account for an increase in noise level, the mean of the noise correlation sum may be subtracted (i.e., demeaning) from the peak to obtain the TOA quality, instead of simply using the height of the peak above zero directly.

The NCI TOA and associated measurement quality from each sensor may then be provided to a central location server (“LS”) or other LS to determine a location estimate for an MS. In one embodiment, prior to location determination, a quality threshold may be applied to omit sensors with poor TOA measurements. For example, a lower TOA quality threshold may be utilized with an integrated TOA measurement than would otherwise be possible with multiple individual slotted TOA measurements to thereby result in an increase in sensor site participation. The combined effects of improved TOA accuracy and increased site participation afforded by an exemplary NCI measurement process according to embodiments of the present subject matter may thus lead to improved geolocation accuracy.

A further embodiment of the present subject matter may be employed in a multi-channel measurement system. For example, in a typical cell site installation, there may be two radio frequency (“RF”) antennas serving each cellular sector to thereby provide spatial diversity and reduce degradation caused by multipath signal fading. Each RF channel may therefore provide an independent TOA measurement. In an exemplary embodiment, a higher quality TOA may be selected for use in determining the location estimate of an MS. In multipath conditions, the TOA obtained from an RF channel receiving a delayed multipath signal will be significantly later than a direct-path channel measurement. In the absence of multipath, however, the TOA measured in both channels should be nearly the same. When this occurs, added assurance would be provided that the TOA is accurate. To exploit such information, differences in the integrated TOA measured on each channel may be determined in exemplary embodiments. If the difference is less than a predetermined threshold value, such as, but not limited to, 20% of the sample spacing, 50 m, etc., then the TOA measurement quality may be increased by an appropriate factor reflecting an increased confidence in the measurement thereby giving this measurement greater weight in an exemplary location determination.

Another embodiment of the present subject matter may filter slotted TOA measurement data or information prior to an integration thereof. For example, the quality of individual slotted TOA measurements may be utilized to filter out respective slots prior to the integration process thereby improving the integrated TOA measurements. By requiring the slotted TOA quality to be above a predetermined threshold, such as, but not limited to, 9.5 dB, 10 dB, etc., slots that likely do not contain signal energy would not be included in the exemplary integration process. Generally, thresholds should not be set too high as too few slots will be included in the AF summation thereby negating the integration gain. Experimental testing has shown that applying a low threshold on the slotted TOA measurement quality prior to slot integration may result in an improved integrated TOA measurement without loss in detection sensitivity.

When slots are filtered prior to the AF summation, the number of slots utilized may also provide additional information about the quality of the NCI TOA measurement. In the event that fewer slots pass the integration threshold, the respective NCI TOA measurement may likely be less accurate than an NCI TOA measurement in which nearly every slot contains a high quality TOA measurement. This quality may then be adjusted by the number of slots used in the integration so as to reduce the quality in relation to how many slots were omitted. In such a method, measurements from those sensors at which the NCI TOA was created from a relatively large number of slotted TOA measurements would impart a greater influence on the location determination of the respective MS.

As described above, a summation of AF magnitudes from the individual time slots may result in a correlation peak above the noise at the correct TOA. The height of the peak may also provide an indication of the quality of the integrated TOA measurement. Since the individual slot TOAs utilized in the integration also provides an associated TOA quality, the average of the slot TOA qualities may be determined in another embodiment of the present subject matter. This value may then be compared to the integrated TOA measurement quality. The amount of gain of the integrated TOA quality over the average of the slotted TOA qualities is yet another metric that may be utilized to weight the influence of the NCI TOA in the determination of a location estimate of a respective MS. When an exemplary NCI process produces a large peak from individual slots of relatively low quality, it is more likely to be an accurate TOA measurement than when the integration process did not result in much gain over the average quality of the individual slots and the NCI TOA quality increased accordingly.

One benefit of certain embodiments of the present subject matter that integrate the AF across time slots is an improvement in the ability of respective sensor(s) to accurately measure a TOA when the signal being detected is weak. As such, embodiments of the present subject matter may result in more sensors contributing measurements to an exemplary location determination, i.e., more sensors may provide measurements of high enough quality to be used in the computation than would otherwise be the case in which the sensors only report their slotted TOAs and do not perform NCI. Generally, a minimum of three sensors around an MS are required in a TDOA hyperbolic location system. Including additional independent, high quality, measurements from additional sensor locations generally improves this location estimate. Typically, measurements from five or six sites that roughly surround the MS and are receiving signals therefrom well are sufficient for an accurate location determination. The marginal accuracy improvement from each additional sensor generally diminishes as the number of contributing sites increases. On any particular geolocation scenario, there may be an adequate number of sensors contributing slotted TOA measurements so as to make an inclusion of NCI TOA measurements from more distant sites unnecessary.

A hybrid slotted-NCI TOA approach may, however, be implemented in an embodiment of the present subject matter by including the NCI TOA from an additional sensor when there are fewer than a minimum number of slotted TOA sensors contributing measurements. For example, if are only two or three sensors (or fewer) participating without use of the NCI TOA process, then additional sites providing an NCI TOA measurement should be included. If there are already seven sensors participating without use of the NCI TOA, however, then including the NCI TOA from an eighth sensor is unlikely to result in significant location accuracy improvement.

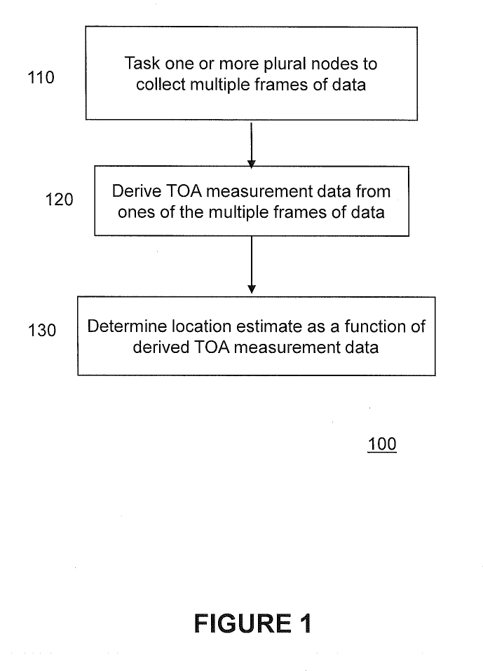

FIG. 1 is a block diagram of one embodiment of the present subject matter. With reference to FIG. 1, a method 100 of determining the location of a mobile appliance in a communications system having a plurality of nodes is provided. At step 110, one or more of the plural nodes may be tasked to collect multiple frames of data from one or more signals transmitted by the mobile appliance. In one embodiment, the collection of multiple frames of data may be synchronous. At step 120, TOA measurement data may be derived from ones of the multiple frames of data wherein the this derived data is non-coherently integrated across the ones of the multiple frames of data, and at step 130, a location estimate of the mobile appliance determined as a function of the derived TOA measurement data. In one embodiment, step 120 may include combining individual TOA measurement data from respective frames of collected data. Of course, the TOA measurement data may be derived using an ambiguity function and may also be derived from independent RF channels. In the embodiment where the TOA measurement data was derived using an ambiguity function, a TOA quality metric may be derived wherein the metric may be a function of a comparison of the height of the integrated TOA measurement data to an average of individual data frame ambiguity function peaks. In the embodiment where the TOA measurement data was derived from independent RF channels, the method 100 may further include weighting the integrated TOA measurement data as a function of a comparison of data between at least two independent RF channels. This combining may be, for example, an average or median of the individual TOA measurement data. In another embodiment, step 130 may include determining location estimates for ones of the multiple frames and averaging the location estimates to determine a final location estimate. In another embodiment, the method 100 may further include the step of deriving a TOA quality metric. This TOA quality metric may be utilized to filter TOA measurement data or weight TOA measurement data. Further, the quality metric may be, in one embodiment, a function of an amount of variation in the TOA measurement data across the ones of the multiple frames. In yet another embodiment of the present subject matter, the method 100 may further include weighting the integrated TOA measurement data as a function of the number of integrated frames of data.

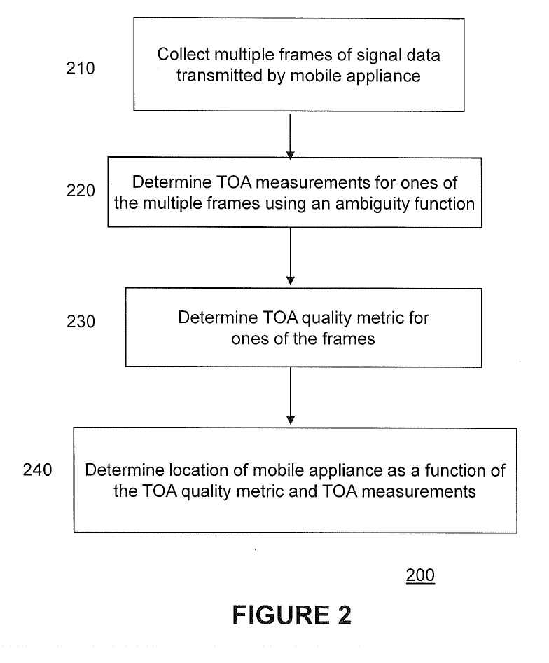

FIG. 2 is a block diagram of another embodiment of the present subject matter. With reference to FIG. 2, a method 200 of determining the location of a mobile appliance in a communications system having a plurality of nodes is provided. At step 210 multiple frames of signal data transmitted by the mobile appliance may be collected and TOA measurements determined for ones of the multiple frames using an ambiguity function at step 220. In one embodiment, the collection of multiple frames of data may be synchronous. In an alternative embodiment, step 220 may include combining individual TOA measurements into a composite TOA measurement. The composite measurement may be an average or median TOA measurement or may be a function of a sum of individual ambiguity function magnitudes across two or more frames. In another embodiment, the TOA measurements may be determined from data collected from independent RF channels. At step 230, a TOA quality metric may be determined for the ones of the multiple frames to filter or weight one or more of the determined TOA measurements. In another embodiment, the quality metric may be determined as a function of the height of the ambiguity function magnitude above noise level. In an additional embodiment, step 230 may include a mean of a noise correlation sum from a peak ambiguity function. Further, the quality metric may be determined as a function of a variation in the TOA measurements across two or more frames. A location of the mobile appliance may then be determined as a function of the determined TOA measurements and TOA quality metric at step 240. In another embodiment, step 240 may include determining location estimates for ones of the multiple frames and averaging the location estimates to determine a final location estimate.

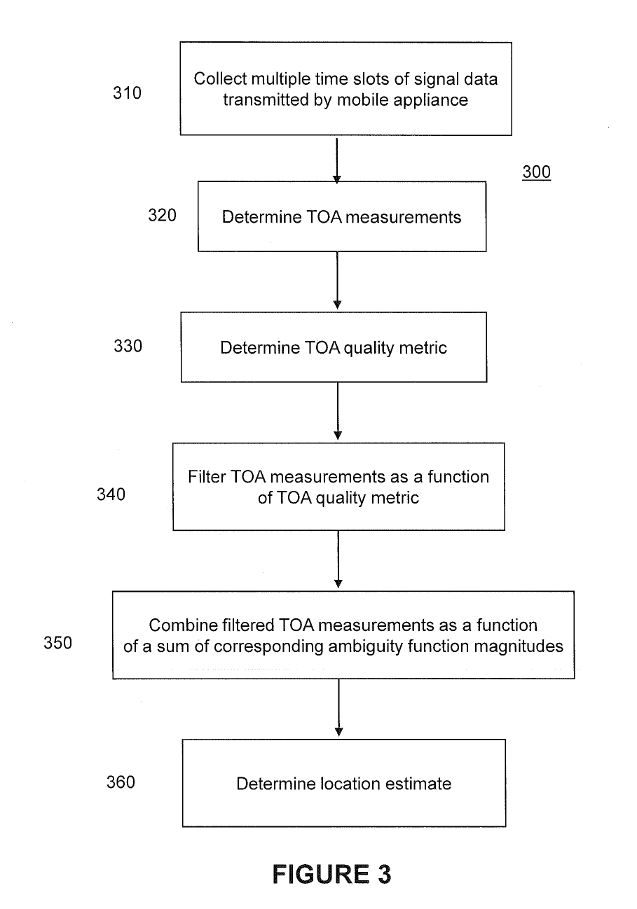

FIG. 3 is a block diagram of a further embodiment of the present subject matter. With reference to FIG. 3, a method 300 of determining the location of a mobile appliance is provided. At step 310, multiple time slots of signal data transmitted by the mobile appliance may be collected, and at step 320 TOA measurements determined for each of the collected multiple slots using an ambiguity function. Of course, the signal data may be collected from independent RF channels. At step 330, a TOA quality metric may be determined, and at step 340 the TOA measurements may be filtered as a function of the quality metric. In one embodiment, the TOA quality metric may be determined as a function of the height of the ambiguity function magnitudes above noise level. In another embodiment, step 330 may include subtracting a mean of a noise correlation sum from a peak ambiguity function. Exemplary TOA quality metrics may be utilized to filter or weight one or more of the determined TOA measurements. At step 350, the filtered TOA measurements may be combined into a composite TOA measurement as a function of a sum of corresponding ambiguity function magnitudes, and at step 360, a location estimate of the mobile appliance determined as a function of the composite TOA measurement.

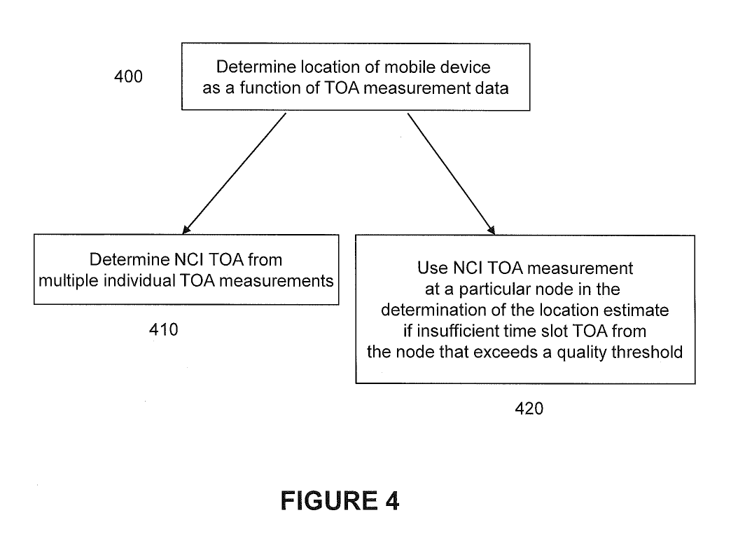

FIG. 4 is a block diagram of additional embodiments of the present subject matter. With reference to FIG. 4, a method 400 of determining the location of a mobile device as a function of TOA measurement data derived from signals received from the device at the nodes is provided. In this embodiment, the method 400 may include the additional step 410 of determining a non-coherently integrated TOA measurement from multiple individual TOA measurements. In another embodiment the method 400 may include the additional step 420 of using a non-coherently integrated TOA measurement at a particular node in the determination of the location estimate if there is insufficient individual time slot TOA measurement data from the particular node that exceeds a predetermined TOA measurement quality threshold. In this embodiment 420, the threshold may be selected from the group consisting of reporting nodes, quality of TOA measurement data, and combinations thereof. Additionally, in this embodiment 420, using a non-coherently integrated TOA may also be a function of the number of nodes contributing acceptable TOA measurements.

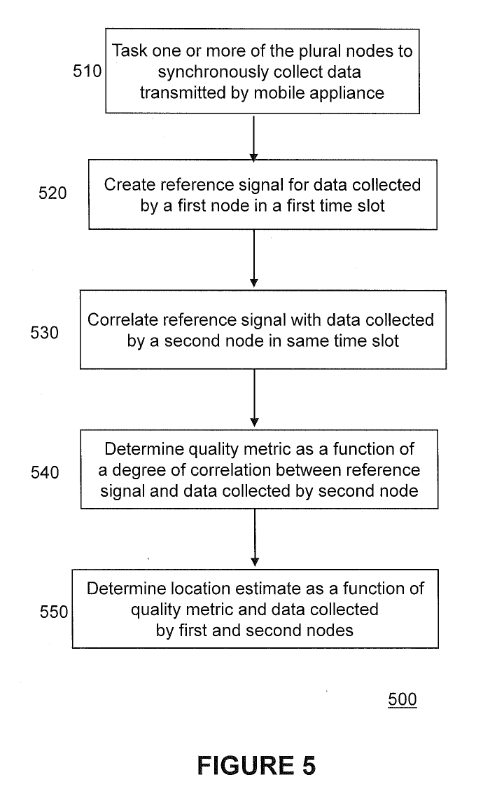

FIG. 5 is a block diagram of one embodiment of the present subject matter. With reference to FIG. 5, a method 500 of determining the location of a mobile appliance in a communications system having a plurality of nodes is provided. At step 510 one or more of the plural nodes may be tasked to synchronously collect data transmitted by the mobile appliance, and at step 520, a reference signal created for data collected by a first node in a first time slot. At step 530, the reference signal may be correlated with data collected by a second node in the same time slot using an ambiguity function. At step 540, a quality metric may then be determined as a function of a degree of correlation between the reference signal and data collected by the second node. This quality metric may be used in certain embodiments to filter or weight the data collected by the first and second nodes prior to determining a location estimate. A location estimate of the mobile appliance may be determined as a function of the data collected by the first and second nodes and the determined quality metric at step 550.

As shown by the various configurations and embodiments illustrated in FIGS. 1-5, a method and system for integrated timing measurements have been described.

While preferred embodiments of the present subject matter have been described, it is to be understood that the embodiments described are illustrative only and that the scope of the invention is to be defined solely by the claims to be appended herewith when accorded a full range of equivalence, many variations and modifications naturally occurring to those of skill in the art from a perusal hereof

What we claim is:

1. A method of determining the location of a mobile appliance in a communications system having a plurality of nodes comprising the steps of:
(a) tasking a plurality of nodes to collect multiple frames of data from one or more signals transmitted by the mobile appliance;
(b) deriving time of arrival (TOA) measurement data from ones of the multiple frames of data; and
(c) determining a location estimate of the mobile appliance as a function of the derived TOA measurement data,
wherein the derived TOA measurement data is non-coherently integrated across the ones of the multiple frames of data.

2. The method of claim 1 wherein the collection of multiple frames of data is synchronous.

3. The method of claim 1 wherein the step of determining a location estimate further comprises determining location estimates for ones of the multiple frames and averaging the location estimates to determine a final location estimate

4. The method of claim 1 wherein the step of deriving further comprises combining individual TOA measurement data from respective frames of collected data.

5. The method of claim 4 wherein the combining further comprises determining an average or median of the individual TOA measurement data.

6. The method of claim 1 further comprising the step of deriving a TOA quality metric.

7. The method of claim 6 wherein the TOA quality metric is used to filter TOA measurement data or weight TOA measurement data.

8. The method of claim 6 wherein the quality metric is a function of an amount of variation in the TOA measurement data across the ones of the multiple frames.

9. The method of claim 1 wherein TOA measurement data is derived using an ambiguity function.

10. The method of claim 9 further comprising the step of deriving a TOA quality metric wherein the metric is a function of a comparison of the height of the integrated TOA measurement data to an average of individual data frame ambiguity function peaks.

11. The method of claim 1 wherein TOA measurement data is derived from independent RF channels.

12. The method of claim 11 further comprising the step of weighting the integrated TOA measurement data as a function of a comparison of data between at least two independent RF channels.

13. The method of claim 1 further comprising the step of weighting the integrated TOA measurement data as a function of the number of integrated frames of data.

14. A method of determining the location of a mobile appliance in a communications system having a plurality of nodes comprising the steps of:
(a) collecting multiple frames of signal data transmitted by the mobile appliance;
(b) determining time of arrival (TOA) measurements for ones of the multiple frames using an ambiguity function;
(c) determining a TOA quality metric for the ones of the multiple frames; and
(d) determining a location of the mobile appliance as a function of the determined TOA measurements and TOA quality metric,
wherein the TOA quality metric is used to filter or weight one or more of the determined TOA measurements.

15. The method of claim 14 wherein the step of determining a location further comprises determining location estimates for ones of the multiple frames and averaging the location estimates to determine a final location estimate.

16. The method of claim 14 wherein the step of determining TOA measurements further comprises combining individual TOA measurements into a composite TOA measurement.

17. The method of claim 16 wherein the composite measurement TOA is an average or median TOA measurement.

18. The method of claim 16 wherein the composite TOA measurement is a function of a sum of individual ambiguity function magnitudes across two or more frames.

19. The method of claim 14 wherein the quality metric is determined as a function of the height of the ambiguity function magnitude above noise level.

20. The method of claim 14 wherein the step of determining a quality metric further comprises subtracting a mean of a noise correlation sum from a peak ambiguity function.

21. The method of claim 14 wherein the quality metric is determined as a function of a variation in the TOA measurements across two or more frames.

22. The method of claim 14 wherein the collection of multiple frames of data is synchronous.

23. The method of claim 14 wherein the TOA measurements are determined from data collected from independent RF channels.

24. A method of determining the location of a mobile appliance comprising the steps of:
(a) collecting multiple time slots of signal data transmitted by the mobile appliance;
(b) determining time of arrival (TOA) measurements for each of the collected multiple slots using an ambiguity function;
(c) determining a TOA quality metric;
(d) filtering TOA measurements as a function of the quality metric;
(e) combining filtered TOA measurements into a composite TOA measurement as a function of a sum of corresponding ambiguity function magnitudes; and
(f) determining a location estimate of the mobile appliance as a function of the composite TOA measurement.

25. The method of claim 24 wherein the TOA quality metric is determined as a function of the height of the ambiguity function magnitudes above noise level.

26. The method of claim 24 wherein the step of determining a quality metric further comprises subtracting a mean of a noise correlation sum from a peak ambiguity function.

27. The method of claim 24 wherein the TOA quality metric is used to filter or weight one or more of the determined TOA measurements.

28. The method of claim 24 wherein the signal data is collected from independent RF channels.

29. In a communications system having a plurality of nodes, a method of determining the location of a mobile device as a function of time of arrival (TOA) measurement data derived from signals received from the device at the nodes, the improvement comprising the step of determining a non-coherently integrated TOA measurement from multiple individual TOA measurements.

30. In a communications system having a plurality of nodes, a method of determining the location of a mobile device as a function of time of arrival (TOA) measurement data derived from signals received from the device, the improvement comprising the step of using a non-coherently integrated TOA measurement at a particular node in the determination of the location estimate if there is insufficient individual time slot TOA measurement data from the particular node that exceeds a predetermined TOA measurement quality threshold.

31. The method of claim 30 wherein the threshold is selected from the group consisting of reporting nodes, quality of TOA measurement data, and combinations thereof.

32. The method of claim 30 wherein the step of using a non-coherently integrated TOA is a function of the number of nodes contributing acceptable TOA measurements.

33. A method of determining the location of a mobile appliance in a communications system having a plurality of nodes comprising the steps of:
(a) tasking one or more of the plural nodes to synchronously collect data transmitted by the mobile appliance;
(b) creating a reference signal for data collected by a first node in a first time slot;
(c) correlating the reference signal with data collected by a second node in the same time slot using an ambiguity function;
(d) determining a quality metric as a function of a degree of correlation between the reference signal and data collected by the second node; and
(e) determining a location estimate of the mobile appliance as a function of the data collected by the first and second nodes and the determined quality metric.

34. The method of claim 33 wherein the quality metric is used to filter or weight the data collected by the first and second nodes prior to determining the location estimate.
